(19) United States
(12) Patent Application Publication
(10) Pub. No.: US 2018/0187619 A1
(43) Pub. Date: Jul. 5, 2018

(54) Method For Vehicle Launch Control Using A Ball Planetary Type Continuously Variable Transmission

(71) Applicant: Dana Limited, Maumee, OH (US)

(72) Inventors: T. Neil McLemore, Georgetown, TX (US); Travis J. Miller, Cedar Park, TX (US); Sebastian J. Peters, Cedar Park, TX (US)

(21) Appl. No.: 15/849,824

(22) Filed: Dec. 21, 2017

Related U.S. Application Data
(60) Provisional application No. 62/441,737, filed on Jan. 3, 2017.

(51) Int. Cl. F02D 41/02; F02D 41/26; B60W 10/06

(52) U.S. Cl. CPC F02D 41/0215; F02D 2250/18; B60W 10/06; F02D 41/26

(57) ABSTRACT

Provided herein is a control system and method for a multiple-mode continuously variable transmission having a ball planetary variator. The control system has a transmission control module configured to receive a plurality of electronic input signals, and to determine a mode of operation from a plurality of control ranges based at least in part on the plurality of electronic input signals. The transmission control module includes a CVP control module. In some embodiments, the transmission control module is adapted to implement a vehicle launch control process. The vehicle launch control process adjust the variator based on the vehicle speed and the driver's demand.

### RELATED APPLICATION

The present application claims the benefit of U.S. Provisional Application No. 62/441,737 filed on Jan. 3, 2017, which is incorporated herein by reference in its entirety.

### BACKGROUND

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that are available to be implemented in a CVT are not sufficient for some applications. A transmission is capable of implementing a combination of a CVT with one or more additional CVT stages, one or more fixed ratio range splitters, or some combination thereof in order to extend the range of available ratios. The combination of a CVT with one or more additional stages further complicates the ratio control process, as the transmission will have multiple configurations that achieve the same final drive ratio.

The different transmission configurations may for example, multiply input torque across the different transmission stages in different manners to achieve the same final drive ratio. However, some configurations provide more flexibility or better efficiency than other configurations providing the same final drive ratio.

Modern vehicles typically employ a variety of technologies to improve driving performance while reducing fuel consumption and improving exhaust emissions. Many techniques are employed for controlling the launch of a vehicle. During a conventional vehicle launch, if the wheel torque exceeds the tractive limit of the tires, the tires will slip, resulting in a loss of acceleration (low launch). Modern vehicles make use of engine torque control to limit the wheel slip once it is detected. By using a CVP to control the transmission output torque (and thereby the wheel torque), the engine can be operated at its optimal power and fuel efficient point, independent of wheel speed and torque

### SUMMARY

Provided herein is a method for controlling a continuously variable transmission having a ball-planetary variator (CVP) provided with a ball in contact with a first traction ring assembly and a second traction ring assembly, wherein the continuously variable transmission is operably coupled to an engine, the method including the steps of: receiving a plurality of input signals indicative of an accelerator pedal position, a vehicle speed, an engine torque, and a wheel speed; evaluating a wheel slip condition based on the plurality of input signals; determining a transmission output torque setpoint based on the accelerator pedal position; determining a CVP ratio setpoint based on the transmission output torque setpoint; and issuing a commanded CVP ratio to impart a change in an operating condition of the CVP.

Provided herein is a vehicle including: a continuously variable planetary (CVP) having a first traction ring assembly and a second traction ring assembly in contact with a plurality of balls, wherein each ball of the plurality of balls has a tiltable axis of rotation; and a controller configured to control a launch condition of the vehicle, the controller adapted to receive a plurality of input signals including an accelerator pedal position signal, a vehicle speed signal, an engine torque signal, and a wheel speed signal; wherein the controller is configured to detect a wheel slip condition based on the plurality of input signals, and wherein the controller issues a commanded CVP speed ratio set point based at least in part on the wheel slip condition.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the devices are utilized, and the accompanying drawings of which:

FIG. 1 is a side sectional view of a ball-type variator.

FIG. 2 is a plan view of a carrier member that used in the variator of FIG. 1.

FIG. 3 is an illustrative view of different tilt positions of the ball-type variator of FIG. 1.

FIG. 4 is a block diagram schematic of a vehicle control system implementable in a vehicle.

FIG. 5 is a flow chart depicting a vehicle control process that is implementable in the vehicle control system of FIG. 4.

### DETAILED DESCRIPTION OF THE PREFERRED EMBODIMENTS

An electronic controller is described herein that enables electronic control over a variable ratio transmission having a continuously variable ratio portion, such as a Continuously Variable Transmission (CVT), Infinitely Variable Transmission (IVT), or variator. The electronic controller can be configured to receive input signals indicative of parameters associated with an engine coupled to the transmission. The parameters can include throttle position sensor values, accelerator pedal position sensor values, vehicle speed, gear selector position, user-selectable mode configurations, and the like, or some combination thereof. The electronic controller can also receive one or more control inputs. The electronic controller can determine an active range and an active variator mode based on the input signals and control inputs. The electronic controller can control a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. patent application Ser. No. 14/425,842, entitled “3-Mode Front Wheel Drive And Rear Wheel Drive Continuously Variable Planetary Transmission” and, U.S. patent application Ser. No. 15/572,288, entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but rather, is optionally configured to control any of several types of variable ratio transmissions.

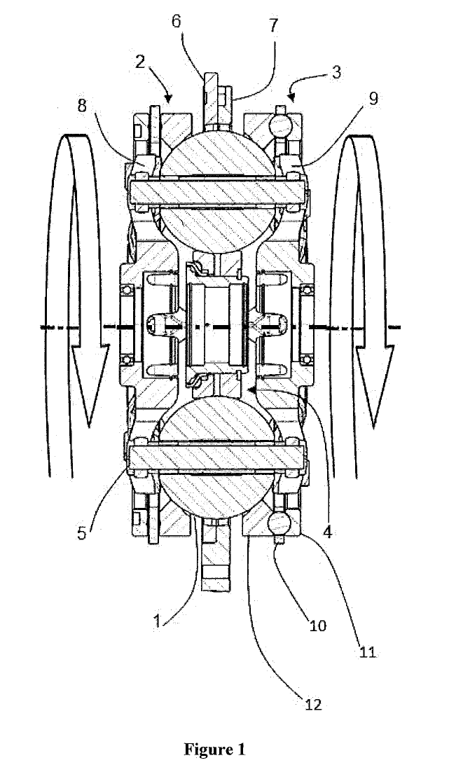

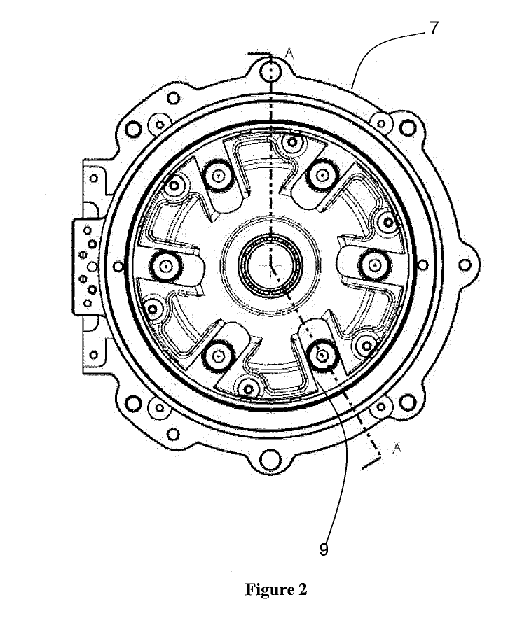

Provided herein are configurations of CVTs based on a ball type variator, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, as input (first) traction ring assembly 2 and output (second) traction ring assembly 3, and an idler (sun) assembly 4 as shown on FIG. 1. In some embodiments, the output traction ring assembly 3 includes an axial force generator mechanism. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjustable to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

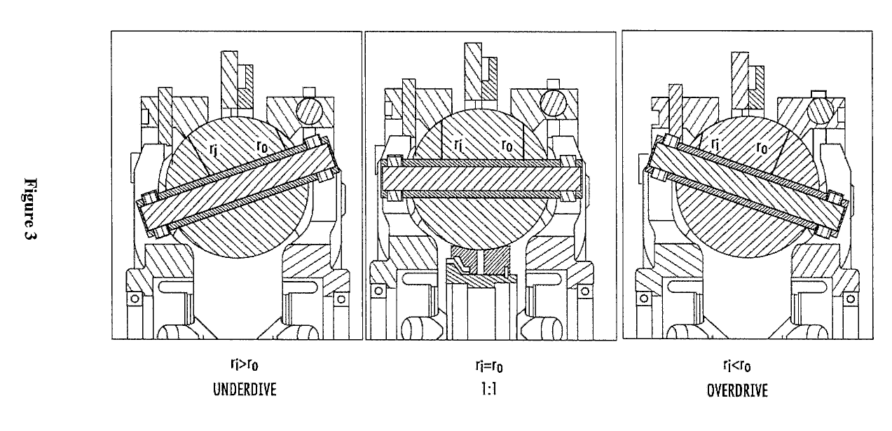

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal, the ratio is one, as illustrated in FIG. 3, when the axis is tilted, the distance between the axis and the contact point change, modifying the overall ratio. All the balls' axes are tilted at the same time with a mechanism included in the carrier and/or idler. Embodiments disclosed herein are related to the control of a variator and/or a CVT using generally spherical planets each having a tiltable axis of rotation that is adjustable to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably coupleable”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial”, as used herein indicates a direction or position that is perpendicular relative to a longitudinal axis of a transmission or variator. The term “axial” as used herein refers to a direction or position along an axis that is parallel to a main or longitudinal axis of a transmission or variator.

It should be noted that reference herein to “traction” does not exclude applications where the dominant or exclusive mode of power transfer is through “friction.” Without attempting to establish a categorical difference between traction and friction drives herein, generally, these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces that would be available at the interfaces of the contacting components and is a measure of the maximum available drive torque. Typically, friction drives generally relate to transferring power between two elements by frictional forces between the elements. For the purposes of this disclosure, it should be understood that the CVTs described here can operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”. Traction fluid is also influenced by entrainment speed of the fluid and temperature at the contact patch, for example, the traction coefficient is generally highest near zero speed and decays as a weak function of speed. The traction coefficient often improves with increasing temperature until a point at which the traction coefficient rapidly degrades.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power transfer direction, in such a case this component of creep is referred to as “transverse creep.”

Those of skill will recognize that the various illustrative logical blocks, modules, circuits, and algorithm steps described in connection with the embodiments disclosed herein, including with reference to the transmission control system described herein, for example, can be implemented as electronic hardware, software stored on a computer readable medium and executable by a processor, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present embodiments. For example, various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Software associated with such modules can reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and write information to, the storage medium. In the alternative, the storage medium can be integral to the processor. The processor and the storage medium can reside in an ASIC. For example, in one embodiment, a controller for use of control of the CVT comprises a processor (not shown).

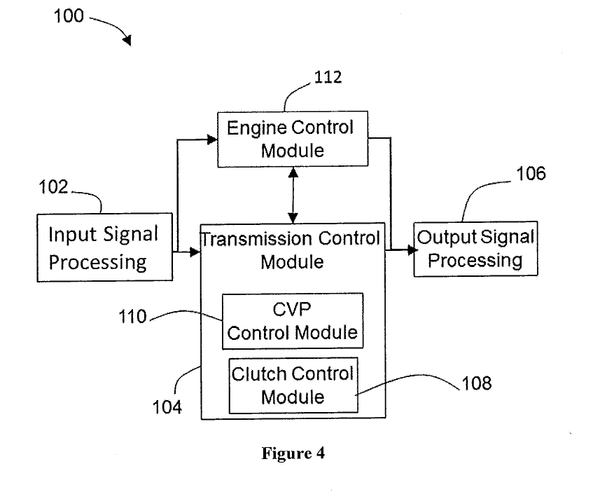

Referring now to FIG. 4, in some embodiments, a vehicle control system 100 includes an input signal processing module 102, a transmission control module 104 and an output signal processing module 106. The input signal processing module 102 is configured to receive a number of electronic signals from sensors provided on the vehicle, transmission, and/or other control modules. The sensors optionally include temperature sensors, speed sensors, position sensors, among others. In some embodiments, the signal processing module 102 optionally includes various sub-modules to perform routines such as signal acquisition, signal arbitration, or other known methods for signal processing. The output signal processing module 106 is optionally configured to electronically communicate to a variety of actuators and sensors, and/or other control modules. In some embodiments, the output signal processing module 106 is configured to transmit commanded signals to actuators based on target values determined in the transmission control module 104. The transmission control module 104 optionally includes a variety of sub-modules or sub-routines for controlling continuously variable transmissions of the type discussed here. For example, the transmission control module 104 optionally includes a clutch control sub-module 108 that is programmed to execute control over clutches or similar devices within the transmission. In some embodiments, the clutch control sub-module implements state machine control for the coordination of engagement of clutches or similar devices. The transmission control module 104 optionally includes a CVP control sub-module 110 programmed to execute a variety of measurements and determine target operating conditions of the CVP, for example, of the ball-type continuously variable transmissions discussed here. It should be noted that the CVP control sub-module 110 optionally incorporates a number of sub-modules for performing measurements and control of the CVP. In some embodiments, the vehicle control system 100 includes an engine control module 112 configured to receive signals from the input signal processing module 102 and in communication with the output signal processing module 106. The engine control module 112 is configured to communicate with the transmission control module 104. It should be appreciated that in some embodiments, the engine control module 112 is optionally configured to have a dedicated input signal processing module and output signal processing module.

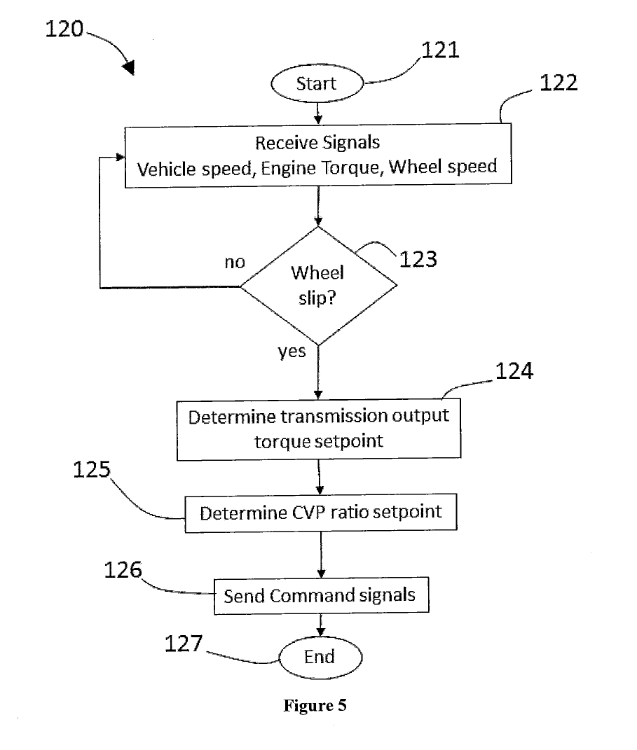

Referring now to FIG. 5, in some embodiments, the transmission control module 104 is configured to implement a vehicle launch control process 120. The vehicle launch control process 120 begins at a start state 121 and proceeds to a block 122 where a number of input signals are received. For example, the input signals are provided by the input signal processing module 102 and include a vehicle speed, an engine torque, and a wheel speed, among others. The vehicle launch control process 120 proceeds to an evaluation block 123 where the signals received in the block 122 are evaluated to determine if slipping of the wheels is occurring during a vehicle launch. In some embodiments, the accelerator pedal position signal and the vehicle speed signal are compared to calibrateable threshold variables to confirm that the vehicle is in a launch condition. As used herein “vehicle launch”, “launch”, and “launch condition” refer to an operating condition when the vehicle is starting to move from a stopped condition. As used herein, the term “wheel slip” refers to an operating condition where the wheel, or tire, of the vehicle has exceeded a tractive limit and spins relative to the ground. In some embodiments, wheel slip is associated with a sudden rise in wheel speed. For example, a change in the wheel speed signal is compared to a calibration variable containing data associated with a minimum threshold for a rate of change of wheel speed indicating slip. In some embodiments, wheel slip is associated with a sudden drop in an output torque measured by a torque sensor located on an output shaft of the transmission. In some embodiments, a pre-calibrated table or set of tables containing data for a tractive limit of the tires based on output torque are employed to determine wheel slip.

The vehicle launch control process 120 proceeds to a block 124 where a transmission output torque setpoint is determined. For example, the transmission output torque setpoint is a value below the current setpoint for torque that satisfies the driver's demanded operating condition. Most modern engine control systems determine driver demanded torque from a factory calibrated table of torque demanded as a function of accelerator pedal position signal. In some embodiments, the value of a demanded torque derived from the table is compared against the actual engine torque, for example, engine torque derived from a measured intake air. In some embodiments, the block 124 is adapted to modify the demanded torque setpoint coming out of the factory calibrated table to a value that will stop the wheel slip.

The vehicle launch control process 120 proceeds to a block 125 where a CVP ratio setpoint is determined based on the transmission output torque setpoint. The vehicle launch control process 120 proceeds to a block 126 where command signals corresponding to the CVP ratio setpoint determined in the block 125 are sent to the CVP control module 110, for example. In some embodiments, the vehicle launch control process 120 proceeds to an end state 127, for example in an open loop control configuration. In other embodiments, the vehicle launch control process 120 proceeds from the block 126 back to the block 122, for example in a closed loop control configuration.

The foregoing description details certain embodiments. It will be appreciated, however, that no matter how detailed the foregoing appears in text, the preferred embodiments are practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the preferred embodiments with which that terminology is associated.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the preferred embodiments described herein can be employed in practicing the preferred embodiments. It is intended that the following claims define the scope of the preferred embodiments and that methods and structures within the scope of these claims and their equivalents be covered thereby.

What is claimed is:

1. A method for controlling a continuously variable transmission having a ball-planetary variator (CVP) provided with a ball in contact with a first traction ring assembly and a second traction ring assembly, wherein the continuously variable transmission is operably coupled to an engine, the method comprising the steps of:
receiving a plurality of input signals indicative of an accelerator pedal position, a vehicle speed, an engine torque, and a wheel speed;
evaluating a wheel slip condition based on the plurality of input signals;
determining a transmission output torque setpoint based on the accelerator pedal position;
determining a CVP ratio setpoint based on the transmission output torque setpoint; and
issuing a commanded CVP ratio to impart a change in an operating condition of the CVP.

2. The method of claim 1, wherein evaluating a wheel slip condition further includes comparing a change in the wheel speed to a calibration variable.

3. The method of claim 1, wherein determining a transmission output torque setpoint further comprises evaluating an operator demand.

4. The method of claim 3, wherein evaluating an operator demand further comprises comparing the accelerator pedal position to a calibration table, wherein the calibration table contains data indicative of a transmission output torque based on the accelerator pedal position.

5. A vehicle comprising:
a continuously variable planetary (CVP) having a first traction ring assembly and a second traction ring assembly in contact with a plurality of balls, wherein each ball of the plurality of balls has a tiltable axis of rotation; and
a controller configured to control a launch condition of the vehicle, the controller adapted to receive a plurality of input signals comprising:
an accelerator pedal position signal,
a vehicle speed signal,
an engine torque signal, and
a wheel speed signal;
wherein the controller is configured to detect a wheel slip condition based on the plurality of input signals, and
wherein the controller issues a commanded CVP speed ratio set point based at least in part on the wheel slip condition.

6. The vehicle of claim 5, wherein the controller is configured to determine a transmission output torque setpoint based on the wheel slip condition.

7. The vehicle of claim 6, wherein the commanded CVP speed ratio is a function of the transmission output torque setpoint.

8. The vehicle of claim 7, wherein the wheel slip condition is detected by a rate of change of the vehicle speed signal.

9. The vehicle of claim 7, wherein the wheel slip condition is detected by a rate of change of a transmission output torque.
